(19) United States
(12) Patent Application Publication
(10) Pub. No.: US 2023/0053551 A1
(43) Pub. Date: Feb. 23, 2023

(54) GAS FLOW AND HEAT TRANSFER APPARATUS

(71) Applicant: OXFORD UNIVERSITY INNOVATION LIMITED, Oxford (GB)

(72) Inventor: Giacomo Gorini, Oxford (GB)

(21) Appl. No.: 17/794,097

(22) PCT Filed: Jan. 21, 2021
(86) PCT No.: PCT/GB2021/050132

§ 371 Date: Jul. 20, 2022

(30) Foreign Application Priority Data
Jan. 21, 2020 (GB) 2000876.9

(51) Int. Cl. B01L 7/02

(52) U.S. Cl. CPC B01L 7/02; B01L 2200/147; B01L 2300/1844; B01L 2300/1894

(57) ABSTRACT

An apparatus arranged to hold at least one vessel. The apparatus includes a frame defining a gas flow pathway and having at least one aperture configured to receive a vessel. The apparatus also includes a device for directing a gas flow along the gas flow pathway, such that when a vessel is located in the aperture, the vessel is positioned at least partially in the gas flow pathway such that heat is transferred between the gas flow and the vessel.

To prepare a reactant for a reaction, it may be necessary to alter the physical state of the reactant. For example, should a reactant be frozen (e.g. for storage purposes), the reactant may need to be thawed before the reaction can begin or the reactant is mixed with other reactants. It may also be necessary to bring reactants to a specific temperature to start the reaction or to bring a reactant mixture to a specific temperature to trigger a specific step in a multistep reaction. Certain reactions may also require to be held at a constant temperature for an extended period of time.

A number of techniques and apparatus are capable of performing these processes. However, often a technique or apparatus which is appropriate for performing one of these processes may not suitable for performing another.

For example, thawing of frozen reactants is often performed using the heat generated by an individual's hands. An individual may individually rub a vial containing a reactant between their hands to thaw the reactant. This is a time-consuming , labour intensive thawing process for the individual. This thawing process is also inefficient as only one vial of reactant can be thawed at a time. Such a technique may also be unsuitable for reactions which require a precise, constant temperature and/or a series of temperature changes.

In a second example, a reaction may be incubated (e.g. kept at a constant temperature for an extended period of time) by a heat block. In a third example, a thermal cycler may be used expose a reaction mixture to a multiple temperature sequence. In a fourth example, eukaryotic or prokaryotic cells may be kept at constant temperature to allow growth or incubation. However, such apparatus are complicated and bulky. This may make them unsuitable for smaller laboratories or laboratories with more limited resources.

An aim of the present invention is to provide an improved apparatus for controlling the temperature of reactants or growth medium.

When viewed from a first aspect, the present invention provides an apparatus arranged to hold at least one vessel, the apparatus comprising:

a frame defining a gas flow pathway therethrough and comprising at least one aperture configured to receive a vessel; and a device for directing a gas flow along the gas flow pathway such that when a vessel is located in the aperture, the vessel is positioned at least partially in the gas flow pathway such that heat is transferred between the gas flow and the vessel.

The present invention provides an apparatus configured to transfer heat to or away from a vessel. The vessel may contain any suitable and desirable substances such as a reactant. A pathway is formed by the frame and a gas is directed along this pathway, forming a gas flow along the pathway.

The frame also provides a support for the vessel such that when a vessel is inserted into an aperture in the frame, the vessel is located at least partially within the gas flow pathway. The vessel therefore comes into contact with the gas flowing through the pathway.

Heat is transferred between the gas and the vessel, and subsequently transferred to or from the substance contained within the vessel. The direction of heat flow between the vessel and the gas may depend on the relative temperatures of the vessel and the gas.

Providing a gas flow helps to prevent a pocket of gas from forming around a vessel, which may affect the temperature and/or decrease the rate of change of temperature of the contents of the vessel. In an example where a vessel contains a frozen substance which requires thawing, should the vessel be left to thaw in an environment with no gas flow, a layer to colder gas forms around the vessel. This slows down the thawing process.

When the vessel is exposed to a gas flow, as described in the present invention, the colder gas layer which forms around the vessel is at least partially removed.

Therefore the rate of change of temperature of the substance contained in the vessel may be increased and subsequently the thawing process accelerated.

Thus it will be appreciated that in at least preferred embodiments, the present invention helps to provide a simple and compact apparatus for transferring heat to or from a substance held within a vessel. For example, the apparatus may be used to thaw a substance contained within a vessel by exposing the vessel to a gas flow.

The apparatus may provide a less labour intensive and increasingly automated alternative to conventional processes for thawing substances, e.g. an individual rubbing a vessel between their hands.

Providing a gas flow through the frame may also allow the apparatus to maintain a vessel at a constant temperature for an extended period of time. The simple and compact nature of the apparatus provided in at least preferred embodiments of present invention may be more suitable for, but not limited to, field work, smaller laboratories and laboratories with limited resources.

The vessel which the at least one aperture is configured to receive may be any suitable and desirable container for a substance. The vessel may be a plate (e.g. a

Petri plate), a test tube or a flask. In a set of embodiments, the vessel is a vial.

The at least one aperture comprising part of the frame may have any suitable and desired shape. In one set of embodiments, the at least one aperture is circular. This makes the aperture suited to receiving a vessel with a circular cross-section.

However, the Applicant has also appreciated that there may be embodiments in which the aperture is a multi-sided shape such as a triangle, square, hexagon or concave decagon (e.g. a star). The shape of the aperture may be regular or irregular.

In a set of embodiments, the shape of the aperture may be similar (or identical) to the cross-sectional shape of a particular vessel. For example, a vessel may have a hexagonal cross-section and therefore a hexagonally shaped aperture is particularly suitable for receiving this vessel. This may result in only certain shaped vessels being suitable for insertion into certain shaped apertures.

The at least one aperture comprising part of the frame of the present invention may have any suitable and desirable size. The width of the aperture (e.g. at its widest part) may between 10 mm to 17 mm, e.g. 12 mm to 14 mm, e.g. 12.15 mm. In a set of embodiments wherein the at least one aperture is circular, the width of the aperture is substantially equal to the diameter of the aperture (i.e. the diameter of the at least one aperture may be between 10 mm to 17 mm, e.g. 12 mm to 14 mm, e.g. 12.15 mm).

Different diameter apertures may be suitable for receiving different sized vessels. The diameter of the aperture may be chosen to be similar to the diameter of a particular type of vessel. This helps a vessel to be held securely by an aperture, and may allow for easy insertion and removal of the vessel to and from the aperture. For example, an aperture with a diameter of 12.55 mm is suitable for receiving a 1.5 ml and/or 2 ml vessel.

Preferably the frame comprises a plurality of apertures arranged such that heat is transferred between the gas flow and any number of vessels received by corresponding apertures. For example, the frame may comprise between 10 to 50 apertures, e.g. 20 to 40 apertures, e.g. 32 apertures. Thus the frame may be suitable for receiving multiple vessels simultaneously.

These embodiments therefore allow heat to be transferred to or from multiple vessels simultaneously, and may make the process of transferring heat to or from multiple vessel more efficient, both in terms of time and resources. For example, compared with the thawing processes in which only one vessel is able to be thawed by an individual at a time, these embodiments may enable a less labour intensive and more efficient thawing process as multiple vessels may be thawed simultaneously.

Preferably the plurality of apertures are uniform in size (e.g. diameter); however the Applicant has appreciated that apertures of different sizes may be provided. Thus, in some embodiments, the frame comprises at least two subsets of apertures, wherein the aperture(s) of a first set have a first width and the aperture(s) of a second set have a second width. The first and second width are preferably different. The width referred to may be the maximum dimension of a given aperture if the width of the aperture is not constant.

Preferably the plurality of apertures are uniform in shape (e.g. triangular, square, hexagonal or concave decagonal); however the Applicant has appreciated that apertures of different shapes may be provided. Thus, in some embodiments the frame comprises at least two subsets of apertures wherein the aperture(s) of a first set have a first shape and the aperture(s) of a second set have a second shape. The first and second shape are preferably different.

Vessels of different shapes and/or sizes can therefore be received by the apertures and can be simultaneously subjected to a temperature change. This allows these embodiments of the apparatus to transfer heat to or from the various shaped and/or sized vessels simultaneously and for example, may be particularly beneficial in laboratories where the present invention may be used for multiple experiments which require various shaped and/or sized vessels (e.g. containing different reactants). This may increase the efficiency with which heat is transferred to (e.g. to thaw the reactants) or from (e.g. to maintain the reactants at a suitable temperatures) a plurality of vessels.

The plurality of apertures may be arranged in any suitable or desired manner. Preferably the plurality of apertures are arranged such that heat is transferred (e.g. equally) between the gas flow and any number of vessels received by corresponding apertures (e.g. regardless of the number of vessels present in the frame and their arrangement relative to each other).

In one set of embodiments, the plurality of apertures are arranged in rows and columns. For example, thirty-two apertures may be arranged in four rows and eight columns. However, in some embodiments, the apertures may not be aligned in rows and columns. In some embodiments, the plurality of apertures are arranged in an irregular pattern. A degree of turbulence of the gas flow resulting from an irregular arrangement of the plurality of apertures may be beneficial to the heat transfer between the gas flow and the vessels.

This arrangement of apertures may increase (e.g. maximise) the number of apertures which can be formed in the frame and therefore increase the number of vessels which may simultaneously be received by the apparatus (i.e. increasing the capacity of the apparatus). This arrangement may also reduce the obstruction to the gas flow between the vessels received by the apparatus (e.g. gas may be able to flow more freely and smooth between and around the vessels), and therefore may improve the heat transfer between the gas flow and vessels.

To help improve the performance of the apparatus, preferably the apertures are arranged such that heat transfer occurs between all vessels held by the frame and the gas flow, regardless of the number of vessels received. Certain arrangements of the apertures are envisaged which may improve the consistency of heat transfer between vessels received by the apertures and the gas flow. Furthermore, the gas flow may be directed (e.g. by the device for directing the gas flow) such that it is distributed (e.g. evenly) through the frame, and thus over the vessels.

In a set of embodiments, the apparatus comprises a cover arranged to cover the at least one aperture. The cover helps to reduce the volume of gas which may escape from the apparatus (e.g. from the gas flow pathway) through the aperture(s), e.g.

when some of the apertures do not hold a vessel. In one embodiment the apparatus comprises one or more caps arranged to cover the one or more apertures respectively.

In a set of embodiments, the cover is arranged to seal the at least one aperture. This may help to increase the volume of gas that propagates through the entire gas flow pathway (e.g. the gas volume that flows along the whole gas flow pathway rather than prematurely escaping through an aperture), therefore helping to increase the volume of gas available to transfer heat to or from any vessels held by the apparatus. This may increase the rate of transfer of heat to or from these vessels and, e.g., increase the rate of thawing of a reactant within a vessel. It may also ensure a more consistent heat transfer to vessels received by various apertures along the gas flow pathway.

To allow a vessel to be received by an aperture when a cover is arranged to cover the aperture, in a set of embodiments the cover comprises at least one opening, e.g. corresponding to (e.g. aligned with) the (e.g. each) aperture. Preferably (e.g. each of) the least one opening is arranged to receive a vessel therethrough to be received by the at least one aperture. In a set of embodiments the opening may comprise a slit (e.g. a small, narrow cut). The opening may comprise two perpendicular slits (e.g. forming a cross) in the cover.

For a frame comprising a plurality of apertures, preferably the cover covers the plurality of apertures. The cover may comprise a plurality of openings where each of the plurality of openings corresponds to (e.g. is aligned with) a respective one of the plurality of apertures (e.g. an opening in the cover is present above each aperture). Each opening may be arranged to receive a vessel therethrough to be received by the respective aperture. This allows vessels to be received by the apertures whilst preferably covering apertures which are not occupied by a vessel, helping to reduce the volume of gas escaping from the apparatus (e.g. from the gas flow pathway) through the unoccupied apertures. Thus preferably the at least one opening is arranged to substantially close (e.g. seal) when the opening does not receive a vessel therethrough. Preferably the at least one opening is arranged to substantially seal around the vessel when the opening receives a vessel therethrough.

Whilst a single cover may cover all of the apertures, in one embodiment each of the apertures may be provided with an individual cover.

Preferably the cover comprises a film. In embodiments in which the apparatus comprises a plurality of apertures, the film is arranged to cover the plurality of apertures. In a set of embodiments, the cover (e.g. film) is formed from a flexible material. A flexible cover (e.g. film) aids the insertion of the vessels through the openings in the cover. Preferably the cover is arranged to deform when a force is applied to the at least one opening (e.g. when a vessel is being inserted into an opening and therefore an aperture). In a set of embodiments the film is formed from a plastic, e.g. silicone, neoprene.

In a set of embodiments, the cover comprises a heater, e.g. an electric heating element. Preferably the heater is arranged to heat the cover to prevent condensation of liquids (e.g. solvents) on the cover and/or vessel lids.

The frame may be formed from any suitable and desirable material. Preferably the frame is formed from an insulating material. This may help to reduce the heat transfer between the gas flow (and/or the vessels) and the surrounding environment. For example, when the apparatus is used to transfer heat from the gas flow to the vessels, forming the frame from an insulating material may reduce the heat loss from the apparatus. This may reduce heat loss from the apparatus to the surrounding environment, which is undesirable as it decreases the (power) efficiency of the apparatus as energy is transferred away from the apparatus. Preferably, the frame is formed from a plastic, e.g. acrylonitrile butadiene styrene (ABS), polypropylene. Such plastics have a high melting point. However, the Applicant also envisages that there may be embodiments in which the frame is formed from a metal, for example.

The frame of the apparatus may be formed in any suitable and desirable shape. The frame is preferably formed from a plurality of portions. In a set of embodiments, the frame comprises a base portion. The base portion may be arranged to support the frame, e.g. on a surface of a table.

In a set of embodiments, the frame comprises a top portion. Preferably, the top portion comprises the at least one aperture configured to receive a vessel.

In a set of embodiments, the frame comprises a side portion, e.g. connecting the bottom and the top portion and/or arranged to support the top portion.

In these embodiments, the side portion may support the top portion such that a vessel inserted into an aperture in the top portion is positioned at least partially in the gas flow pathway, to enable the transfer of heat between the gas flow and the vessel. The frame may further comprise additional side portion(s), which are also connected to the bottom and top portions.

Preferably, the frame is hollow. This may be achieved by the frame comprising a top portion and a plurality of side portions and, e.g. a bottom portion, such that the portions surround an empty volume. The hollow frame may define the gas flow pathway. In a set of embodiments, the frame is a hollow prism, e.g. a hollow cuboid.

In a set of embodiments, the frame comprises an entrance for the gas flow and an exit for the gas flow. Preferably the device for directing the gas flow along the gas flow pathway is arranged (e.g. coupled to the frame) to direct the gas flow through the entrance for the gas flow. Preferably, the gas flow pathway is formed between the entrance for the gas flow and the exit for the gas flow. The gas may then flow through the frame (e.g. through the hollow portion of the frame) to the exit.

In some embodiments, the frame comprises two portions: a first (e.g. lower) portion comprising a tunnel and a second (e.g. upper) portion comprising the exit for gas flow (from the frame). Preferably the second portion is arranged above the first portion.

Preferably, the second portion comprises the at least one aperture configured to receive a vessel. The first portion preferably comprises the entrance for gas flow (from the frame) and (at least of portion of) the gas flow pathway is defined by the tunnel. Preferably the tunnel is arranged to extend from the entrance for the gas flow towards the exit for the gas flow (e.g. along the length of the frame).

In some embodiments, the device for directing the gas flow along the gas flow pathway (e.g. coupled to the frame) is arranged to direct (at least a portion of) the gas flow through the tunnel.

In a set of embodiments, the tunnel comprises one or more openings, e.g. in an upper surface of the tunnel. Preferably, the opening(s) are arranged (spaced) along the length of the tunnel. Preferably, the opening(s) are arranged to direct the gas flow through the opening(s) in the tunnel into the second (e.g. remaining) portion of the frame.

Preferably, the opening(s) in the tunnel are aligned with the aperture(s) in the frame. Preferably, the opening(s) are arranged to direct the gas flow through the opening(s) in the tunnel towards the aperture(s), such that the gas flow comes into contact with any vessels, e.g. inserted into the aperture(s) in the frame. This helps the gas flow to be distributed evenly throughout the frame, helping to provide a constant temperature of the air flow throughout the frame. This helps to provide consistent heating and/or cooling of vessels, e.g. inserted into aperture(s) in the frame.

The entrance and exit may be formed in the side portions of the frame. The entrance for the gas flow may comprise an aperture in a side portion of the frame through which the gas flow can be directed. The exit may comprises at least one aperture, and for example may be plurality of slits, in a side portion.

The exit may be arranged to be selectively (at least partially) opened and closed. In a set of embodiments, the apparatus (e.g. frame) comprises a (e.g. hinged or slidable) shutter arranged to (e.g. at least partially) open or close the exit. For example, (e.g. partially) closing the aperture reduces the gas flow exiting the frame. At least partially closing the aperture may help to maintain a constant temperature within the frame. For example, (partially) opening the aperture increases or enables gas flow through the aperture, which may help to accelerate an increase or decrease in temperature within the frame.

Preferably, the entrance and exit are formed in geometrically opposite side portions. For example, if the frame is a (e.g. substantially) hollow cuboid, the entrance is formed in one (square) face of the cuboid and the exit is formed in the opposite (square) face of the cuboid. This forms a (e.g. linear) gas flow pathway, which may reduce the turbulence of the gas flow through the pathway to a suitable level. However, in some embodiments, the Applicant has appreciated that some degree of turbulence may be desired, so that gas forming the gas flow mixes along the length of the gas flow pathway. This may reduce the progressive cooling of the gas flow as it flows through the gas flow pathway (e.g. from one vessel to a progressive vessel).

In a set of embodiments, the frame comprises a rack (e.g. a tray) positioned within the gas flow pathway. Preferably, the rack (e.g. tray) is located within the frame between the entrance for the gas flow and the exit for the gas flow. The rack may be configured to receive (e.g. support) at least one vessel (e.g. a Petri dish), such that the vessel is positioned at least partially in the gas flow pathway, such that heat is transferred between the gas flow and the vessel.

The Applicant has appreciated that the apparatus comprising a rack is novel and inventive in its own right. Therefore, when view from a second aspect the present invention provides an apparatus arranged to hold at least one vessel, the apparatus comprising:

a frame defining a gas flow pathway therethrough and comprising at least one rack configured to receive at least one vessel; and

a device for directing a gas flow along the gas flow pathway such that when a vessel is located within the rack, the vessel is positioned at least partially in the gas flow pathway such that heat is transferred between the gas flow and the vessel.

As will be appreciated by those skilled in the art, this aspect of the present invention can, and preferably does include any one or more or all of the preferred and optional features of the present invention discussed herein, as appropriate.

Whilst preferably the plurality of portions of the frame are formed from the same material, the Applicant has appreciated that there may be other embodiments in which different portions of the frame may be formed from different materials.

The Applicant has appreciated that the device may use any suitable and desirable gas for forming the gas flow. The gas flow may use a single gas or a composition of gases. In a set of embodiments, the gas is formed from inert gas(es) e.g. nitrogen and/or argon, to avoid reactions involving the gas flow occurring within the apparatus or in the local environment should a portion of the volume of gas escape.

Preferably, the apparatus comprises a gas supply in fluid connection with the device for directing gas flow along the gas flow pathway, wherein the gas supply is arranged to supply gas to the device for providing the gas flow. The gas may be supplied to the apparatus via a supply line and/or a (compressed) gas canister.

In a set of embodiments, the gas flow is formed from air. This may allow for air from the apparatus surroundings to be used and may alleviate the need to supply a gas to the apparatus, e.g. from a gas canister. This may simplify the apparatus and allow the apparatus to be more compact.

The device for directing a gas flow along the gas flow pathway may be arranged with respect to the frame in any suitable and desirable manner such that the gas flow may propagate along the gas flow pathway. Preferably, the device for directing a gas flow along the gas flow pathway is connected to the frame.

This connection may be formed in any suitable and desirable manner. In embodiments in which the frame comprises an entrance for the gas flow, the device for directing gas flow is arranged to direct the gas through the entrance (into the gas flow path). This may be achieved by the device being connected to the entrance and/or the side portion of the frame comprising the entrance.

In a set of embodiments, the device for directing the gas flow is mounted on the frame. For example, the device for directing the gas flow may be a separate component of the apparatus (e.g. separate to the frame) and mounted on the frame, e.g. using a fastener or an adhesive.

In a set of embodiments, the device for directing the gas flow is integral to the frame. An integral device for directing gas flow along the gas flow pathway may help to reduce the volume of gas which may otherwise be lost between the device for directing gas flow and the frame, and therefore may increase the overall efficiency of the apparatus.

In a set of embodiments the apparatus comprises a device for generating a gas flow. Such a device thus generates a gas flow for flowing through the frame of the apparatus, e.g. to be directed by the device for directing the gas flow. Preferably the device for directing the gas flow along the gas flow pathway is arranged to generate the gas flow, e.g. the device for directing the gas flow along the gas flow pathway comprises the device for generating the gas flow. This reduces the number of components of the apparatus, which may allow the apparatus to be more compact. The device for generating the gas flow may be connected to the gas supply, when provided.

The gas flow could be generated in any suitable and desirable manner. In a set of embodiments, the gas flow is generated by a fan. Thus preferably the device for generating the gas flow comprises a fan. For example, the fan may be arranged with respect to the entrance for the gas flow, such that when the fan operates (e.g. rotates) a flow of gas is produced which is directed towards the entrance in the frame.

In set of embodiments, the gas flow is generated by a pump. Thus the device for generating the gas flow comprises a pump.

Preferably the gas flow rate (e.g. the volume of gas that flows through the gas flow pathway in a given time interval) is controllable, e.g. variable. In embodiments in which the gas flow is generated by a fan, preferably the (e.g. power supplied to the) fan is arranged to be controlled to control (e.g. vary) the speed (e.g. rate of rotation) of the fan. Controlling (e.g. varying) the speed of the fan controls (e.g. varies) the gas flow rate. Thus the rate of heat transfer to or from the contents of vessels may be controlled (e.g. varied).

In a set of embodiments in which the gas flow is generated by a pump, preferably the (e.g. power supplied to the) pump is arranged to be controlled to control (e.g.

vary) the pumping speed of the pump. Controlling (e.g. varying) the pumping speed of the pump controls (e.g. varies) the gas flow rate. Thus the rate of heat transfer to or from the contents of vessels may be controlled (e.g. varied).

The gas flow may allow heat to be transferred from the gas to the substance in the vessel (i.e. increasing the temperature of the substance). In some embodiments the apparatus for implementing such a heat transfer does not require a heating element. This may reduce the number of components in the apparatus, reducing risks associated with heating elements (e.g. fire hazards) and decreasing the power consumption of the apparatus.

However preferably, in a set of embodiments, the apparatus comprises a heating element arranged to heat the gas flow. Preferably the device for generating the gas flow and/or the device for directing the gas flow comprises the heating element. The heating element may be arranged to heat the gas before the gas enters the gas flow pathway. Preferably the temperature of the gas flow is controllable (e.g. variable).

In a set of embodiments, the apparatus comprises a cooling element arranged to cool the gas flow. Preferably the device for generating the gas flow and/or the device for directing the gas flow comprises the cooling element. The cooling element may be arranged to cool the gas before the gas enters the gas flow pathway. Preferably the temperature of the gas flow is controllable (e.g. variable).

In a set of embodiments, the cooling element comprises a cooling medium. The cooling medium may comprise a cooled (or cold) gas, liquid or solid. In a set of embodiments, the cooling element comprises a gas supply. The apparatus (e.g. frame) may comprise an input for supplying the gas. Preferably, the gas supply is cooled (e.g. supplied from a compressed canister) or is air supplied (e.g. cooled or at room temperature) from the local environment. In a set of embodiments, the (e.g. cooling medium of the) cooling element comprises ice or dry ice. Preferably the apparatus (e.g. frame) comprises one or more compartments arranged to receive (e.g. contain) ice or dry ice.

In a set of embodiments, the apparatus comprises a heating element and a cooling element. Thus the apparatus may be arranged to (selectively, e.g. alternatively) heat or cool the gas to control the temperature of the gas flow.

The temperature of the gas flow may be varied in any suitable and desirable manner. Preferably the (e.g. power supplied to the) heating and/or cooling element is arranged to be controlled to control (e.g. vary) the temperature of the heating and/or cooling element, e.g. (preferably continuously) between a lower (colder) limit and an upper (hotter) limit. Controlling (e.g. varying) the temperature of the heating and/or cooling element controls (e.g. varies) the temperature of the gas flow, e.g. (preferably continuously) between a lower (colder) limit and an upper (hotter) limit. Thus the rate of heat transfer to or from the contents of vessels may be controlled (e.g. varied), e.g. (preferably continuously) between a lower limit and an upper limit.

Varying the gas flow rate and/or the temperature of the gas flow may vary the rate of heat transfer to or from the gas flow to vessels received by the apertures and/or rack, and therefore the rate of heat transfer to or from the contents of the vessels. For example, depending on an experiment's and/or reaction's requirements, the contents of vessels may be desired to be thawed more rapidly (e.g. should they been needed for urgently for a particular experiment) or more slowly (e.g. to promote specific crystal formation). Controlling the rate of transfer of heat to a vessel containing a mixtures of reactants may prevent a ‘run-away’ reaction.

The skilled person will appreciate that it may be necessary to supply power to the apparatus (e.g. to the device of generating gas flow (e.g. to rotate the fan) and/or the heating and/or cooling element). Whilst it may be preferable for the apparatus to be provided with power from an external source, in some embodiments the apparatus comprises a battery for supplying power to the apparatus. Including a battery in the apparatus as a power source may increase the suitability of the apparatus for field work.

Whilst the apparatus may be configured such that a user can manually vary the gas flow rate or temperature (e.g. using a knob), the Applicant has appreciated it may be desirable to have a control system. Therefore, in a set of embodiments the apparatus comprises a control system arranged to control one or more components of the apparatus.

The control system may be arranged to control one or more components of the apparatus, for example the device for generating the gas flow (e.g. a fan, a pump and/or a heating and/or cooling element). In a set of embodiments, the control system may be arranged to control the gas flow rate and/or the temperature of the gas flow, e.g. by controlling one or both of the (e.g. pump or fan of the) device for generating the gas flow and the heating and/or cooling element.

The skilled person will appreciate that the control system may control the gas flow rate and/or temperature of the gas flow by controlling the device for generating the gas flow. For example, the control system may be arranged to vary the speed of rotation of the fan to vary the gas flow rate and/or alter the power supplied to a heating and/or cooling element to vary the temperature of the gas flow.

The control system may be configured or controlled externally, e.g. by a user. In a set of embodiments, the control system comprises a transmitter and/or receiver for communicating with an external device. This may enable the control system to be configured or controlled (e.g. remotely) by an external device. The external device may comprise a smartphone. For example, the user may use an application on the smartphone to control the gas flow rate and/or temperature of the gas flow.

The control system may be controlled or configured manually. In a set of embodiments, the apparatus (e.g. the control system) may comprises a user operable control. For example, the user operable control may be a switch, dial and/or a user interface (e.g. a touch screen). A switch, dial or user interface may enable one or more variables to be varied (preferably continuously), e.g. between upper and lower limits. For example, the speed of rotation of the fan and/or current through the heating element may be adjusted (preferably continuously), e.g. between upper and lower limits.

However, preferably the control system is arranged to control components of the apparatus automatically (e.g. without requiring an input from an individual). This may enable the control system to adjust and control changes in the state of the apparatus, which may lead to a more reliable apparatus for, e.g., maintaining vessels (reactants) at a constant temperature or heating vessels at a constant rate.

In a set of embodiments, the control system comprises one or more sensors. Preferably, the one or more sensors are arranged to measure a variable (e.g. one or more (e.g. all) of temperature, humidity, gas flow rate). At least some of the one or more sensors may be arranged to measure multiple variables (such as a temperature-humidity sensor). The one or more sensors may be located at any suitable and desired spatial positions on (e.g. within) the apparatus. Preferably the sensors are located (at various different spatial positions) within the frame.

The one or more sensors may comprise a temperature sensor (e.g. a thermistor) arranged to measure the temperature of the gas flow (e.g. in the gas flow pathway). The one or more sensors may be a gas flow rate sensor arranged to measure the gas flow rate of the gas flow (e.g. in the gas flow pathway). The one or more sensors may be a humidity sensor arranged to measure the humidity of the gas flow (e.g. inside the frame).

The one or more sensors may be located on the apparatus and preferably within the frame in the gas flow pathway. This helps to ensure the measurement provided by the sensor(s) corresponds to a variable (e.g. temperature, humidity, gas flow rate) the vessels are subjected to.

The apparatus may be arranged to provide an alert (e.g. to a user), for example relating to a variable measured by one or more of the sensors. For example, an alert may be provide when the temperature of the gas flow has reached a certain temperature or if the temperature of the gas flow falls outside a predetermined range.

The alert may be provided in any suitable and desirable form. In a set of embodiments, the apparatus comprises a light and/or a speaker. For example, a single tone note from the speaker or the light turning on may indicate the temperature of the gas flow has reached a certain temperature.

In a set of embodiments in which the control system comprises a transmitter and/or receiver for communicating with an external device, the alert may be provided on the external device (e.g. a notification on the screen of a smartphone). In a set of embodiments, the control system comprises a processor (e.g. a microprocessor) for receiving one or more measurements from one or more of the sensors and/or for controlling operation of the apparatus. The processor is preferably arranged to receive one or more measurements from the one or more sensors e.g. an input comprising data representative of respective measurements captured by the one or more sensors. The processor may be configured to compare the measured variable(s) to a reference value(s).

The reference value(s) may be predefined for a particular apparatus or process, or may be input by a user. For example, should it be necessary to maintain a vessel at a particular temperature for an extended period of time, a user may set a specific temperature e.g. 37° C. The sensor may be arranged to measure the temperature and output a temperature measurement to the processor. The processor then compares this measurement to the reference temperature and, for example, controls operation of the apparatus based on this comparison.

The user may provide the reference value(s) in any suitable and desirable manner. For example, the user may provide a reference value as an input using a user operable control or an external device (in communication with the control system). The user interface and/or the external device may also be operable to adjust a variable and/or indicate an operational time of the apparatus.

In a set of embodiments, the processor is arranged to output one or more control signals to the device for generating gas flow and/or the heating and/or cooling element (e.g. for controlling operation thereof) based on the one or more measurements from the one or more sensors. The control signal may, for example, be used to control the speed of rotation of the fan and/or the current through the heating element, and therefore may be used to control the gas flow rate and/or temperature.

In embodiments in which these processes are repeated, the control system may be used as a feedback system. In a set of embodiments, the control system comprises a proportional—integral—derivative (PID) controller. The PID controller aids the automation of the feedback system, e.g. by controlling the heating and/or cooling element differentially. This may help to maintain the vessels at a constant temperature for an extended period of time.

The one or more sensors may be arranged to measure a respective variable periodically, for example, every minute.

The processor may be arranged to determine whether a variable measured by a sensor is outside a reference range. The processor may compare a measurement from a sensor to a reference range. The reference range may be selected by a user or a range centred on a variable (e.g. desired) value (i.e. a tolerance). When the measurement from the sensor is outside of the reference range (e.g. should the temperature sensor measure the temperature to be 25° C. and the reference range is 27-30° C.), the processor may be arranged to output one or more control signals to the device for generating gas flow and/or the heating and/or cooling element (e.g. for controlling operation thereof).

For example, the heating element may be switched on when the temperature measurement from the sensor is below the lower bound of the reference range and the heating element may be switched off when the temperature measurement from the sensor becomes above the lower bound of the reference range. For example, the cooling element may be switched on when the temperature measurement from the sensor is above the upper bound of the reference range and the cooling element may be switched off when the temperature measurement from the sensor becomes below the upper bound of the reference range. This may be used in a system where control of the device for generating gas flow and/or the heating and/or cooling element is limited to being on or off.

The processor may be arranged to alter the variable(s) during operation of the apparatus. For example, the processor may be arranged to maintain a vessel held by the apparatus at a first temperature for a first time period and then at a second temperature for a second time period. The processor may be arranged to control the rate of change of a variable. Cycles of changes and/or rates of changes in variables may be implemented in accordance with predetermined cycles stored in a memory (e.g. of the control system) or may be input by a user (e.g. using the user interface or the external device).

In a set of embodiments, the apparatus comprises a container for containing the gas flow. In a set of embodiments the container is integral to the frame. The container may surround the entire apparatus. In a set of embodiments, the container only surrounds the top portion of the frame. In such embodiments, the container may form an enclosed volume over the apertures (and any vessels received by the apertures) of the frame (e.g. not over the entrance or exit for gas flow).

Similarly to the cover, the container helps to reduce the volume of gas which may escape from the apparatus, for example through the aperture(s) by forming a seal over the aperture(s). Providing a container reduces the volume of gas flow which escapes to the local environment, which may increase the efficiency of the apparatus. Reduces the volume of gas flow which escapes to the environment may be particularly important in embodiments in which the gas flow is formed from a gas other than air which may be dangerous (e.g. toxic or flammable) or in which a particular gas composition (e.g. CO₂ concentration) is required (e.g. to allow cell culture survival).

In a set of embodiments, the container comprises a heater, e.g. an electric heating element. Preferably the heater is arranged to heat the container (e.g. surrounding the top portion of the frame) to prevent condensation of liquids (e.g. solvents) on the container and/or vessel lid.

In a set of embodiments, the container comprises an at least partially removable portion. For example, the at least partially removable portion may comprise a lid or a door of the container. The at least partially removable portion may be automatically or manually secured (e.g. locked), for example, during operation of the apparatus.

In a set of embodiments, the apparatus comprises a secondary input for providing one or more supplies to the apparatus. In embodiments in which the apparatus comprises a container, the container may comprise the secondary input. It will be appreciated that the apparatus may comprise a plurality of secondary inputs. The plurality of secondary inputs may provide various supplies (e.g. gases, water) to the apparatus. The control system may further be arranged to control a supply received by the secondary input. The apparatus may comprise one or more sensors arranged to measure supply variables (e.g. the rate of gas and/or water flow, and/or the level(s) of gas(es) in the container).

For example, the secondary input may be arranged to receive a CO₂ supply, which may be required for growing cells in vessels (received by the apertures and/or the rack) under incubator conditions. The control system may be arranged to control the CO₂ concentration within the apparatus by controlling the CO₂ input. The apparatus may comprise one or more sensor(s) arranged to measure the CO₂ concentration (e.g. inside the container). Maintaining the CO₂ concentration at a (e.g. approximately) constant level within the apparatus may be important, e.g. for eukaryotic cell growth.

In another embodiment, the secondary input may be arranged to receive (and thus preferably the apparatus comprises) a water supply. The control system may be arranged to control the humidity within the apparatus (e.g. in the gas flow pathway) by controlling the water input. The apparatus may comprise one or more sensors arranged to measure the humidity. Controlling the humidity within the apparatus is important for e.g. eukaryotic cell growth.

The apparatus may further comprise a table, wherein the table is arranged to support the frame. The table may be connected to the frame and/or form part of the base portion of the frame. The table may be arranged to move (e.g. vibrate) to generate a movement of the frame, and thus of any vessels received by the apparatus and their contents. The disturbance of the contents of the vessels may, for example, help to stimulate bacteria or eukaryotic cell growth.

The frame may comprise a platform arranged to generate movement of the vessels. In such an embodiment, the platform may be arranged to contact the vessels.

Preferably, the apparatus comprises a motor for generating the movement of the table and/or the platform.

In a set of embodiments in which the control system comprises a transmitter and/or receiver for communicating with an external device, the external device may be separate from the apparatus that is arranged to hold the vessel(s). The control system may be arranged to communicate with one or more additional apparatus (e.g. each according to the present invention), for example, to control the additional apparatus and/or co-ordinate the operation of the (multiple) apparatus. This may enable reactions to be achieved in parallel in different apparatus.

In a set of embodiments, the apparatus comprises a plurality of modular components. The apparatus may comprise a common processor arranged to recognise and connect to the plurality of modular components. The frame, the heating and/or cooling element, and the device for generating gas flow may be modular elements. The apparatus may be arranged such that the modular elements are interchangeable. For example, a first frame may be interchanged for a second frame, where the size of the apertures of the first frame are different to the size of the apertures of the second frame. For example, a first frame comprising aperture(s) may be interchanged for a second frame comprising a rack. This may enable the apparatus to be used for a wider variety of applications.

In a set of embodiments, the apparatus is arranged to thaw a frozen substance contained within a vessel.

In a set of embodiments, the apparatus is arranged to incubate a substance contained within a vessel.

In a set of embodiments, the apparatus is arranged to cool a substance contained within a vessel.

In a set of embodiments, the apparatus is arranged to provide suitable conditions for enzyme-mediated reactions. This may involve maintaining a vessel at a constant temperature (e.g. a temperature at which enzymes are active) for a prolonged time period. In a set of embodiments, the apparatus is arranged to provide suitable conditions for, e.g. restriction enzyme DNA digestion.

In a set of embodiments, the apparatus is arranged to provide suitable conditions for the incubation of a protein-protein interaction (e.g. an enzyme-linked immunosorbent assay (ELISA) test).

In a set of embodiments, the apparatus is arranged to provide suitable conditions for the incubation of a bacteria cells for growth in culture and/or eukaryotic cells.

In a set of embodiments, the apparatus is arranged to provide suitable conditions for a polymerase chain reaction. In particular, the apparatus may be arranged to cycle between cooling and warming, to provide colder and warmer temperatures to facilitate such reactions.

Certain embodiments of the present invention will now be described, by way of example only, with reference to the accompanying drawings in which:

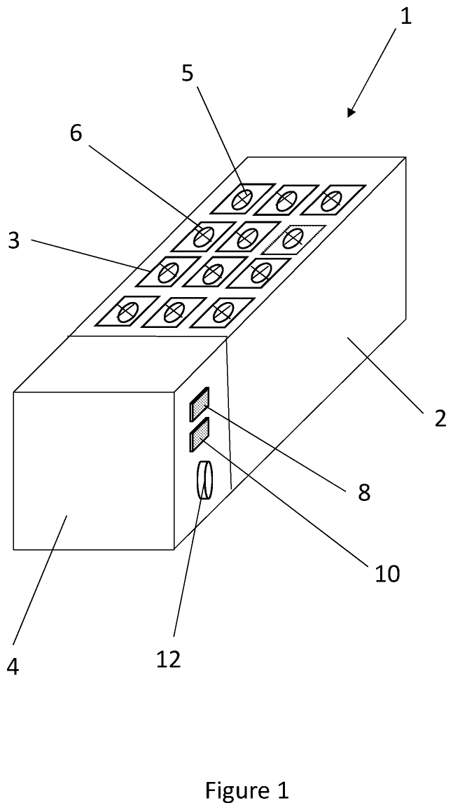

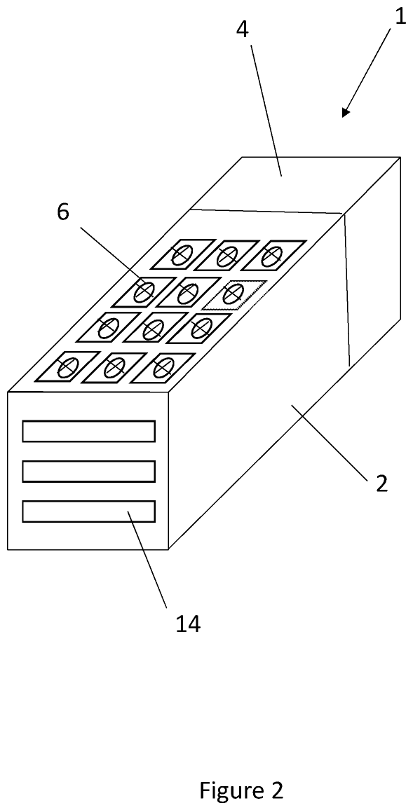

FIGS. 1 and 2 show schematic views of the apparatus in accordance with an embodiment of the present invention;

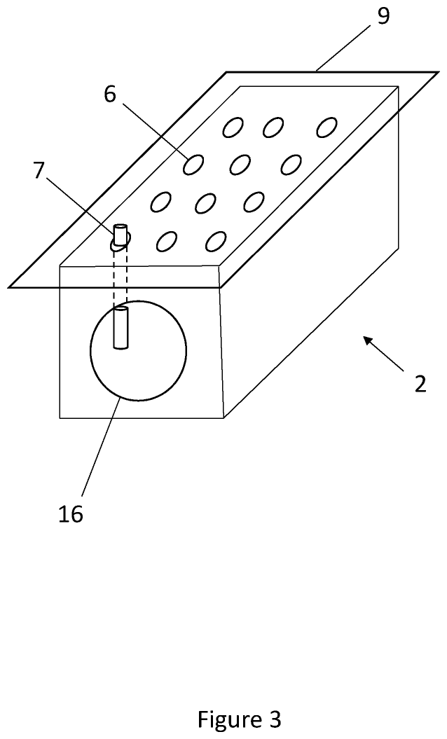

FIG. 3 is an isolated schematic view of the frame of the apparatus shown in FIGS. 1 and 2;

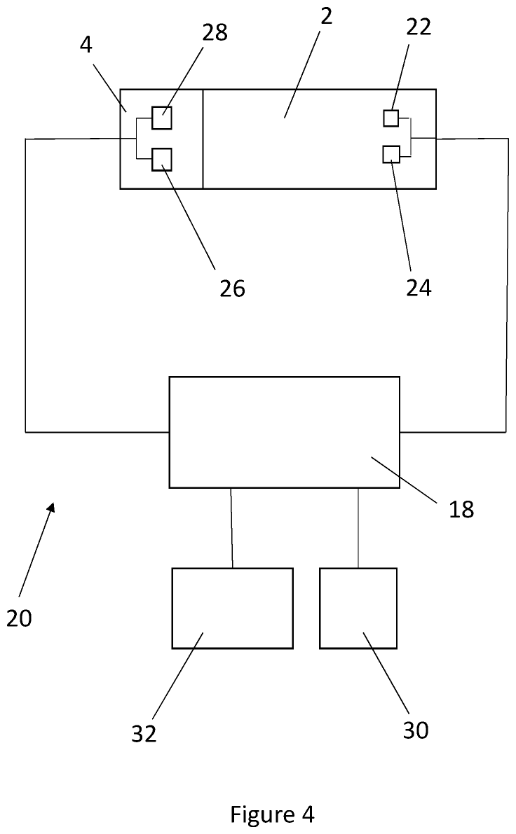

FIG. 4 is a diagram of a feedback system that is used with the apparatus in an embodiment of the present invention;

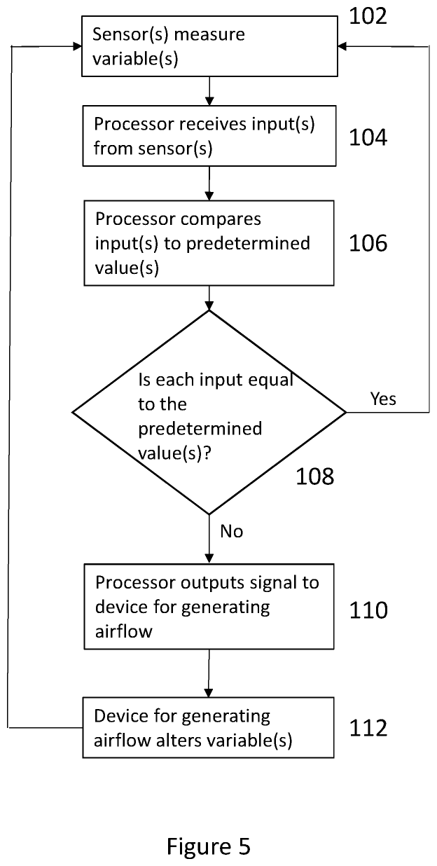

FIG. 5 is a flow chart for the feedback system shown in FIG. 4;

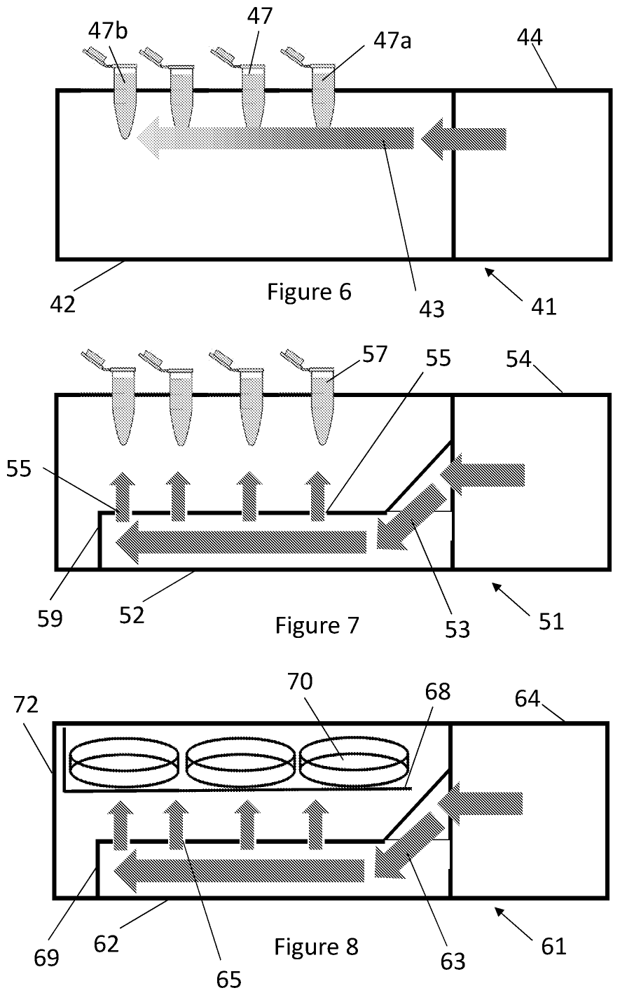

FIG. 6 shows a schematic cross-sectional view of the apparatus in accordance within an embodiment of the present invention;

FIG. 7 shows a schematic cross-sectional view of the apparatus in accordance with another embodiment of the present invention; and

FIG. 8 shows a schematic cross-sectional view of the apparatus in accordance with another embodiment of the present invention.

Embodiments will now be described in relation to the Figures which are arranged to transfer heat between a gas flow and a vial e.g. to thaw a substance contained within a vial by exposing the vial to a gas flow.

FIGS. 1 and 2 shows a schematic views of the apparatus 1 in accordance with an embodiment of the present invention. The apparatus 1 may be arranged to thaw and/or maintain at a constant temperature reactants contained within one or more vials. As can be seen from FIGS. 1 and 2, the apparatus 1 comprises a frame 2 and an air flow generator 4.

The air flow generator 4 is arranged to both generate an air flow and direct this generated air flow into the frame 2. The air flow generator 4 generates air flow using a fan (not shown in FIGS. 1 and 2). The fan rotates in order to generate an air flow.

The air flow generator 4 may comprise a heating element (not shown in FIG. 1). The heating element is arranged to transfer heat to the generated air flow and therefore alter the temperature of the air flow. The fan and the heating element will be discussed in more detail in relation to FIGS. 4 and 5.

In order to power the fan and the heating element, the air flow generator 4 includes a battery (not shown). However, in some embodiments the air flow generator 4 may be connected to a mains power supply which supplies power to the fan and the heating element. The air flow generator 4 also comprises a power switch 8, as shown in FIG. 1. When the power switch 8 is ‘on’, power is supplied from the battery to the fan and to the heating element.

As can be seen in FIG. 1, the air flow generator 4 includes a heating switch 10 and an air flow rate controller 12. The heating switch 10 is arranged to connect (and disconnect) the heating element to the power source (e.g. battery). The air flow rate controller 12 is a dial which can be adjusted by the user to alter the rate of air flow delivered by the fan. The air flow controller 12 is thus arranged to control operation of the fan.

The frame 2 is a hollow cuboid which defines an air flow pathway and is shown in more detail in FIGS. 2 and 3. The frame 2 comprises various apertures and openings.

As can be seen from FIGS. 1 to 3, the top portion of the frame 2 comprises a plurality of apertures 6. These apertures 6 are configured such that a vial can be inserted into each of them. In FIG. 3, a vial 7 is shown inserted into one of the plurality of apertures 6 such that it is contained predominately within the frame 2 and is exposed to the air flow through the frame 2.

In FIGS. 1 and 2, the frame also comprises a plurality of covers 3 corresponding the plurality of apertures 6. Each of the covers 3 contains a slit 5. Each of the slits 5 in formed from two perpendicular cuttings which form a cross over the corresponding aperture. A vial can be inserted through a cover 3 via the slit 5 such that it is held by the apertures.

When a vial is inserted into an aperture 6, the vial is exposed to the air flow in the air flow pathway. Whilst in FIGS. 1 to 3 all the apertures are circular and the same size (e.g. have identical diameters), in embodiments not shown the apertures could have various shapes and sizes.

As can be seen in FIG. 3, showing the frame 2 in isolation, the frame 2 comprises an entrance 16 for air flow in one of its faces. The frame 2 also comprises an exit 14 for air flow in another of its faces. The exit 14 is formed from three lateral rectangular openings in a face of the frame 2 (see FIG. 2). The exit 14 and entrance 16 are formed in opposite end faces of the frame 2, thus forming a linear air flow pathway through the frame.

In the arrangement shown in FIG. 3, a single cover 9 is arranged to provide a seal over the plurality of apertures 6. The cover 9 includes a plurality of slits 5 formed from two perpendicular cuttings in the cover 9. Each of the plurality of slits 5 has a corresponding position to one of the plurality of apertures 6.

FIG. 4 shows a schematic diagram of a feedback control system to be used with the apparatus 1 shown in FIG. 1-3, in accordance with an embodiment of the present invention. In FIG. 4, the frame 2 is shown to further comprise a temperature sensor 22 and an air flow rate sensor 24. The sensors 22, 24 are located inside the frame 2, and therefore are contacted by the gas flow through the frame 2. The temperature sensor is arranged to measure the temperature of the air flow. The air flow rate sensor 24 is arranged to measure the flow rate of the air flow.

In embodiments not shown, the frame may comprise different and/or additional sensors, e.g. a humidity sensor.

The sensors 22, 24 shown in FIG. 4 are connected to a processor 18. The sensors provide an input to the processor 18 based on the measurements they make. The processor 18 is also connected to the fan 26 and the heating element 28 in the air flow generator. The processor is arranged to control the fan 26 and the heating element 28 as will be discussed in more detail in relation to FIG. 5.

FIG. 4 also shows the processor 18 connected to (e.g. forming part of) a computer system 32 (e.g. a laptop) and a screen 30. It will be appreciated that the processor 18 may be located on, and thus forming an integral part of, the (e.g. frame of the) apparatus 1. Either or both of the computer system 32 and the screen 30 could be omitted in other embodiments of the invention.

Operation of the apparatus will now be discussed with reference to FIGS. 1-4 and the flow diagram of FIG. 5.

The air flow generator 4 is arranged to direct the generated air flow through the entrance 16 in the frame 2 into the air flow pathway formed by the frame 2. The fan 26 rotates to generate the air flow. The fan 26 is arranged such that the air flow is directed towards the entrance 16 of the frame 2.

The heating element 28 is positioned within the air flow generator 4 such that the air flow (generated by the fan 26) contacts the heating element 28 before entering the frame 2. The heating element 28 transfer heat to the air of the air flow, so that the temperature of the air is increased. In certain embodiments, the heating element 28 may be positioned such that it heats the air before it enters the fan 26 and the air flow is produced.

After entering the frame 2, the air flow then propagates through the air flow pathway (i.e. the interior of the hollow frame 2 until it passes through the exit 14 in the frame 2. The heated air flow through the frame 2 transfers heat to a vial in the frame 2, and helps to prevent a pocket of air from forming around the vial. This helps to or heat the contents of the vial. (It will be appreciated that an air flow that is not heated could still be used to heat (e.g. thaw) a vial, owing to it being warmer than the vial and/or by helping to prevent a pocket of air forming around the vial. Likewise an air flow that is (e.g. cooled to be) cooler than a vial may be used to cool the contents of a vial)

Operation of the feedback system shown in FIG. 4 will now be described with reference to FIG. 5. FIG. 5 is a flow chart of the feedback system formed by the apparatus shown in FIG. 4.

When an airflow is generated within the frame 2 (i.e. along the air flow pathway) by the air flow generator 4 as described above, the sensors 22, 24 are arranged to measure a variable property associated with the air flow (step 102). The temperature sensor 22 is arranged to measure the temperature within the frame 2 (i.e. the temperature of the air flow) and the air flow rate sensor 24 is arranged to determine the speed of the air flow through the frame 2. Both the temperature of the air flow and the rate of air flow will affect the rate of heat transfer to or from vials held by the apertures 6.

In step 104, the measurements obtained by the sensors 22, 24 are received by the processor 18. These measurements may be displayed on the screen 30. This may allow a user to observe any changes in the temperature and gas flow rate within the frame 2.

In step 106, the processor compares the measurements obtained by the sensors to reference values. For example, it may be desirable to maintain a constant temperature of gas flow in the frame 2 (e.g. in order to maintain reactants in vials at a constant temperature). The reference temperature in this example would be the desired constant temperature. The reference values may have been input by a user, for example using the computer system 32.

The processor then determines whether either of the measurements from the sensors 22, 24 deviate from the corresponding reference value (step 108). Depending the accuracy required, there may be an allowable threshold of deviation between the measurement and the reference value.

If neither of the measurements from the sensors 22, 24 deviates from its reference value by more than the allowable threshold, the processor does not output a signal to the air flow generator 4. The process then returns to step 102 and the process is repeated. The process shown in the flow chart may not be repeated until a period of time, e.g. 30 seconds, has elapsed (since the previous measurement was obtained by the sensors). Alternatively the measurement may be captured and compared to the reference values continuously.

If either (or both) of the measurements from the sensors 22, 24 deviates from its reference value by more than the allowable threshold, the processor 18 outputs a control signal to the gas flow generator 4 (step 110). The control signal may act to control either (or both of) the fan 26 and the heating element 28.

The temperature of the gas flow is altered by changing the current through the heating element 28. For example, should the temperature of the air flow be too low, the processor 18 may output a control signal which increases the current through the heating element 28 (and therefore the temperature of the heating element 28).

The air flow rates is altered by changing the rotation speed of the fan 26. For example, should the speed of the air flow be too slow, the processor 26 may output a control signal which increases the speed of rotation of the fan 26.

Overall, the control signal alters the variable properties of air flow in the frame (step 112). The process then returns to step 102 and is repeated. The process shown in the flow chart may not be repeated until a period of time, e.g. 30 seconds, has elapsed (from the previous test). Repeating the test may allow for the desired values of the variable properties of the gas flow to be reached without overshooting the desired value.

The apparatus 1 also comprises heating switch 10 and an air flow rate controller 12 that allow the conditions within the frame 2 to be altered manually (e.g. by a user).

The heating switch 10 allows the user to choose whether power is supplied from the power supply to the heating element 28 to heat the gas flow (i.e. when the heating switch 10 is in its ‘on’ configuration) or power is not supplied to the heating element 28 such that the gas flow is not heated (i.e. when the heating switch 10 is in its ‘off’ configuration). It will be appreciated that the heating element could be controlled by a dial rather than a switch to allow the air flow to be heated by varying amounts.

The air flow rate controller 12 is a dial which can be rotated to alter the air flow rate by changing the rotation speed of the fan 26. For example, when the air flow rate controller 12 is rotated in one direction, the rotation speed of the fan 26 is increased and therefore the rate of air flow is increased. When the air flow rate controller 12 is rotated in the other direction, the rotation speed of the fan 26 is decreased and therefore the rate of air flow is decreased.

The heating element 28 and the fan 26 can be controlled separately, e.g. by the user. For example, air flow may generated by the fan 26 (i.e. the fan 26 is supplied with power from the battery) without the air flow being heated by the heating element 28 (when the heating switch 10 is in its ‘off’ configuration).

FIGS. 6, 7 and 8 show schematic cross-sectional views through apparatus according to various embodiments of the present invention. The components of the apparatus shown in FIG. 6, 7 or 8 may be incorporated into the apparatus shown in FIGS. 1 and 2.

FIG. 6 shows a schematic cross-sectional view through an apparatus 41 in accordance with an embodiment of the invention. Similarly to the apparatus shown in FIGS. 1 and 2, the apparatus 41 comprises a frame 42 and an air flow generator 44. Vials 47 are shown inserted into apertures in the frame 42. The air flow generator 44 and a heating element (not shown) generate a heated air flow 43 which is directed into the frame and come into contact with the vials 47. For example, the air flow 43 may transfer heat to the vials 47 to increase the temperature of the vials 47 and therefore the contents of the vials 47.

It will be noted that the arrangement shown in FIG. 6 may result in a temperature gradient in the air flow over the length of the frame 42, as the air flow 43 becomes cooled as it propagates along the length of the tunnel owing to transferring heat to the vials 47. This may lead to vials 47a closer to the air flow generator 44 receiving a greater heat transfer than those vials 47b further from the air flow generator 44.

FIG. 7 shows a schematic cross-sectional view through an apparatus 51 in accordance with another embodiment of the invention. Similarly to the apparatus shown in FIGS. 1, 2 and 6, the apparatus 51 comprises a frame 52 and an air flow generator 54. Vials 57 are also shown inserted into apertures in the frame 52. However, the apparatus 51 additionally comprises a tunnel 59, below the apertures in the frame 52, and which includes a number of openings 55. In FIG. 7, the openings 55 are evenly spaced along the length of the tunnel 59, such that the openings 55 are below and aligned with the apertures in the frame 52.

The air flow generator 54 generates an air flow 53 that is directed into the tunnel 59 (rather than directly into the main body of the frame, as shown in FIG. 6). The air flow 53 propagates along the tunnel 59. Portions of the air flow 53 exit the tunnel 59 through the openings 55 in the tunnel 59 and transfer heat to the vials 57. Providing a tunnel 59 with a number of opening 55 helps to provide a more even distribution of the air flow 53 from the air flow generator 54 throughout the frame 52, leading to a more constant temperature over the length of the frame 52 and a more even heat transfer to vials 47 over the length of the frame 52.

FIG. 8 shows a schematic cross-sectional view through an apparatus 61 in accordance with another embodiment of the invention. Similarly to FIG. 7, the apparatus 61 comprises a frame 62, an air flow generator 64 and a tunnel 69 with a number of openings 65. Additionally, the apparatus 61 comprises a tray 68 positioned within the frame 62 above the tunnel 69. The tray 68 supports a number of Petri dishes 70. Similar to the vials shown in FIG. 6, the Petri dishes 70 are heated by heat transfer from the air flow 63 generated by the air flow generator 64 and which passes through the openings 65 to be directed to the Petri dishes 70 on the tray 68. The frame 62 may also include a (e.g. hinged) door 72, to allow the tray 68 and the Petri dishes 70 to be removed (and re-inserted).

It can be seen from the above that in at least preferred embodiments, the present invention provides an apparatus for transferring heat to or away from a vessel by providing a gas flow. Providing a gas flow helps to prevent a pocket of gas from forming around a vessel, which may affect the temperature and/or decrease the rate of change of temperature of the contents of the vessel. This may allow for greater control over the rate of cooling or heating of the contents of the vessel, and for example, may provide a less labour intensive and increasingly automated alternative to conventional processes for thawing substances.

1. An apparatus arranged to hold at least one vessel, the apparatus comprising:
a frame defining a gas flow pathway therethrough and comprising at least one aperture configured to receive a vessel; and
a device for directing a gas flow along the gas flow pathway such that when a vessel is located in the aperture, the vessel is positioned at least partially in the gas flow pathway such that heat is transferred between the gas flow and the vessel.

2. The apparatus as claimed in claim 1, wherein the at least one aperture is circular.

3. The apparatus as claimed in claim 1, wherein the frame comprises a plurality of apertures arranged such that heat is transferred between the gas flow and any number of vessels received by corresponding apertures of the plurality of apertures.

4. The apparatus as claimed in claim 1, wherein the apparatus comprises a cover arranged to cover the at least one aperture.

5. The apparatus as claimed in claim 4, wherein the cover comprises at least one opening corresponding to the at least one aperture, wherein the opening is arranged to receive a vessel therethrough to be received by the at least one aperture.

6. The apparatus as claimed in claim 3, wherein the apparatus comprises a cover comprising a plurality of openings arranged to cover the plurality of apertures, wherein each opening of the plurality of openings corresponds to a respective aperture of the plurality of apertures, wherein each opening is arranged to receive a vessel therethrough to be received by the respective aperture.

7. The apparatus as claimed in claim 5, wherein the at least one opening is arranged to substantially close when the at least one opening does not receive a vessel therethrough and is arranged to substantially seal around the vessel when the at least one opening receives a vessel therethrough.

8. The apparatus as claimed in claim 5, wherein the cover is arranged to deform when a force is applied to the at least one opening.

9. The apparatus as claimed in claim 1, wherein the frame comprises a top portion and a side portion arranged to support the top portion, wherein the top portion comprises the at least one aperture configured to receive a vessel; and
wherein the frame comprises a rack positioned within the gas flow pathway and arranged to receive at least one vessel.

10. (canceled)

11. An apparatus arranged to hold at least one vessel, the apparatus comprising:
a frame defining a gas flow pathway therethrough and comprising at least one rack configured to receive at least one vessel; and
a device for directing a gas flow along the gas flow pathway such that when a vessel is located within the rack, the vessel is positioned at least partially in the gas flow pathway such that heat is transferred between the gas flow and the vessel.

12. The apparatus as claimed in claim 1, wherein the frame is a hollow prism; and
wherein the frame comprises an entrance for the gas flow and an exit for the gas flow, wherein the gas flow pathway is formed between the entrance for the gas flow and the exit for the gas flow.

13. (canceled)

14. The apparatus as claimed in claim 1, wherein the frame comprises:
a first portion comprising a tunnel comprising one or more openings, wherein the tunnel at least partially defines the gas flow pathway; and
a second portion comprises comprising an exit for the gas flow, wherein the one or more openings in the tunnel are arranged to direct the gas flow into the second portion.

15. (canceled)

16. The apparatus as claimed in claim 1, wherein the device for directing the gas flow along the gas flow pathway is arranged to generate the gas flow.

17. The apparatus as claimed in claim 1, comprising a device for generating the gas flow.

18. The apparatus as claimed in claim 17, wherein the device for generating the gas flow comprises a fan, and wherein the fan is arranged to be controlled to control the speed of the fan.

19. The apparatus as claimed in claim 17, wherein the device for generating a gas flow comprises a pump, and wherein the pump is arranged to be controlled to control the pumping speed of the pump.

20. The apparatus as claimed in claim 1, wherein the apparatus comprises one or both of:
a heating element arranged to heat the gas flow; and
a cooling element arranged to cool the gas flow;
wherein the heating element is arranged to be controlled to control the temperature of the gas flow and the cooling element is arranged to be controlled to control the temperature of the gas flow.

21. (canceled)

22. The apparatus as claimed in claim 17, comprising a heating and/or cooling element arranged to heat and/or cool the gas flow, and a control system arranged to control one or both of the device for generating the gas flow to control a gas flow rate of the gas flow and the heating and/or cooling element to control a temperature of the gas flow.

23. The apparatus as claimed in claim 22, wherein the control system comprises one or both of a gas flow rate sensor arranged to measure a gas flow rate of the gas flow and a temperature sensor arranged to measure a temperature of the gas flow.

24. The apparatus as claimed in claim 23, wherein the control system comprises a processor arranged to receive one or more measurements from the one or both sensors and arranged to output one or more control signals to one or both of the device for generating the gas flow and the heating and/or cooling element based on the one or more measurements from the one or more sensors.

25-28. (canceled)
